(19) United States
(12) Patent Application Publication
(10) Pub. No.: US 2022/0395005 A1
(43) Pub. Date: Dec. 15, 2022

(54) ENZYME-MODIFIED EGG YOLK PRODUCTS

(71) Applicant: MICHAEL FOODS, INC., MINNETONKA, MN (US)

(72) Inventor: SIQUAN LI, GAYLORD, MN (US)

(73) Assignee: MICHAEL FOODS, INC., MINNETONKA, MN (US)

(21) Appl. No.: 17/846,019

(22) Filed: Jun. 22, 2022

Related U.S. Application Data
(63) Continuation of application No. PCT/US22/12836, filed on Jan. 18, 2022.
(60) Provisional application No. 63/139,771, filed on Jan. 20, 2021.

(51) Int. Cl. A23L 15/00; A23L 27/60

(52) U.S. Cl. CPC A23L 15/25; A23L 27/60; A23V 2002/00

(57) ABSTRACT

An enzyme-modified egg yolk product can be provided in liquid or powder form. It can be used to make a mayonnaise with a very high viscosity, even in the absence of any thickening additives, and exhibiting good stability at temperatures of greater than 90° C. (e.g., 200° F.).

### CROSS-REFERENCE TO RELATED APPLICATIONS

This application is a continuation of international appl. PCT/US2022/012836 filed Jan. 18, 2022, which claims priority to U.S. patent appl. No. 63/139,771 filed Jan. 20, 2021, both of which are incorporated herein by reference in their entireties.

### BACKGROUND INFORMATION

Eggs are used as and in a variety of food ingredients and products. Egg ingredients for production traditionally have been in the form of whole (shell) eggs., but advances in science and engineering technology have brought about numerous alternatives including liquid and dried or powder egg products, which are able to be treated with enzymes to improve their functionality and use.

Egg yolk is a complex oil-water emulsion of ˜50% water, ˜32% lipids and ˜16% protein. Approximately 28% of the lipids are phospholipids, which are useful in the manufacture of enzyme-modified egg yolk and finished goods manufactured therefrom. About three-fourths of the phospholipids in egg yolk are phosphatidylcholine, with the remaining phospholipids being, in descending order of prevalence, phosphatidylethanolamine, lysophosphatidylcholine, sphingomyelin, lysophosphatidylethanolamine, plasmalogen and inositol phospholipid.

Egg yolk powders typically contain ˜60% lipids, including phospholipids and lysophospholipids. The protein profile in egg yolk includes ˜68% low density lipoprotein (lipovitellin), 12% high density lipoprotein, 12% livetins, and 7% phosvitin. The majority of egg yolk proteins and lipids/phospholipids form lipoprotein complexes and micelles.

In foods, emulsifier(s) often is/are part of a complex matrix which can contain other molecules, both surface active and not. Factors such as ionic strength and pH can significantly impact the activity of the emulsifier.

In the United States, 21 C.F.R § 169.140 requires that mayonnaise must contain not less than 65% (w/w) vegetable oil, at least 2.5% (w/w) acetic or citric acid, and some manner of egg yolk. Certain optional ingredients (e.g., salt, sugar, etc.) are permitted.

Egg yolk acts as a natural emulsifier between the oil and water phases, providing excellent emulsification by reducing the surface energy between polar and non-polar components. Due to the presence of various lipid and protein types in egg yolk, it has useful emulsifying and gelation properties, which makes it useful in recipes for products such as mayonnaise. Egg yolk contains surface active components which contain both hydrophobic and hydrophilic domains. These surface active components are able to stabilize an emulsion by forming an interfacial layer around the emulsion droplets and providing kinetic stability of the emulsion.

Mayonnaises made with currently available enzyme-modified yolk products typically have viscosities in the range of from 4200 to 4800 cP. Gums and starches often are used in combination with egg yolk to increase the viscosity of the continuous phase and thereby decrease creaming of the emulsion. Viscosity enhancers can negatively impact emulsion stability by causing depletion flocculation.

Commercially available enzyme-modified egg yolk products, of the type used to make mayonnaise products in the first viscosity range noted above, provide desired heat stability at temperatures of at least ˜90° C., particularly in the range of ˜93° to ˜99° C. (200° to 210° F.). Conversely, mayonnaise products made with plain (non-modified) egg yolk exhibit emulsion stability problems at lower temperatures, e.g., 70° to 80° C. (158° to 176° F.). Stability issues manifest as “oil off,” breakdown, or separation of the emulsion.

To enhance mayonnaise emulsions, properties such as fat droplet size, surface area, surface tension, and viscosity often are areas of focus.

Controlling degree of hydrolysis (DOH) of egg yolk phospholipids in the aforementioned enzyme-modified egg yolk products has been an area of ongoing research. Increased DOH indeed increases the viscosity of a finished mayonnaise, but enzymatic efficacy of phospholipases (PLAs) is inversely proportional to DOH, meaning longer reaction times which negatively impact production (thereby increasing costs) and product quality (due to extended process time and raw yolk long exposure time to elevated temperature). The elevated amount of free fatty acids in high DOH enzyme-modified yolk products also shortens shelf life and increases quality defects in finished mayonnaise products (due to oxidative quality reduction, such as rancid flavors).

An enzyme-modified egg yolk product that can provide a heat stable mayonnaise having a higher viscosity, e.g., at least 5000 cP and preferably even higher, without the need for added viscosity enhancers or thickeners, remains desirable. This is, particularly true for those mayonnaise producers which sell to users desiring a mayonnaise that can better retain shape during use (e.g., sandwich builders) and to users desiring mayonnaise products with less oil yet still exhibiting organoleptic properties such as creaminess and full mouthfeel.

### SUMMARY

Food processors, including but not limited to mayonnaise producers, have a demand for a non-salt added, enzyme-modified yolk product, to enable them to make high viscosity (≥5000 cP) and heat stable (≥93° C.) mayonnaise products. Such products, either liquid or in a dry (powder) form, can find particular utility in sandwich building due to resistance to flow, which assists in holding together the sandwich components, yet retention of fullness of mouthfeel and creaminess. They also can provide significant benefits to product handling, both during processing and in use by an end consumer.

Provided herein is an enzyme-modified egg yolk powder that can be used to provide a heat stable, high viscosity mayonnaise. Surprisingly, this is accomplished while simultaneously keeping DOH low. No chemical additives or ingredients are required in the product's manufacture, providing a clean formula and label for the mayonnaise.

Also disclosed are processes providing both an enzyme-modified egg yolk and mayonnaise products incorporating it.

In one aspect is provided a process for providing a modified egg yolk product. First, liquid egg yolk is heated to a temperature of ˜57° to ˜61° C. (134° to 142° F.) for a time, t, that varies based on the yolk temperature, T_{y}, according to the formula

t=m(65° C.−T_{y}) (I)

where m is a constant, 54 sec/° C. Yolk temperature then is reduced to ˜43° to ˜54° C. (110° to 130° F.) before a sufficient amount of an aqueous solution of a generally regarded as safe (GRAS) food grade base is added to the yolk so as to provide a caustic intermediate having a pH of 8.05±0.25 units. To this intermediate is added an enzymatic liquid, with the temperature of the resulting mixture being held at a temperature of from ˜46° to ˜52° C. (115° to 125° F.) for ˜50 to ˜250 minutes. Optionally, the process also can include pasteurizing the modified egg yolk product and/or spray drying it so as to yield a powder version of the modified egg yolk product.

Elevation of yolk temperature prior to pH adjustment is believed to enhances the susceptibility of yolk proteins and protein-lipid complexes to later enzymatically catalyzed reactions and to interaction with other yolk components.

The foregoing process results in a hydrolyzed egg yolk product which, when used to make a mayonnaise product, results in a product having different viscosity and heat stability performance characteristics than those resulting from use of currently available enzyme-modified egg yolk products. Processes used in providing the latter focus on controlling degree of hydrolysis of phospholipids (reflected as percent free fatty acids in the enzyme-modified yolk); however, the impacts of such modifications on protein functionality and altered yolk proteins has been overlooked.

In another aspect is provided a hydrolyzed liquid egg yolk that includes from 4 to 6% (w/w) oleic acid (an industry accepted indication of total free fatty acids). The egg yolk pH, when measured at a temperature of from 120° to 124° F., is from 6.8 to 7.3.

Also provided is an egg yolk powder, made from the foregoing liquid egg yolk, that includes from 4 to 6% (w/w) oleic acid.

These modified egg yolk products, in both liquid and powder forms, advantageously have improved emulsifying properties in the egg yolk itself, as well as an ability to stabilize otherwise incompatible ingredients.

In yet another aspect is provided a mayonnaise that includes a hydrolyzed egg yolk product but that is free of added thickeners, which is heat stable up to at least 200° F. and has a viscosity at 20° C. of at least ˜4700 cP when measured at a shear speed of 160 rpm after 120, 240 or even 300 seconds of elapsed time. At elevated temperatures (e.g., 93° C. (200° F.)), little to no oil-off or emulsion breakage or cooking burns are evident. The viscosity of the finished mayonnaise product is such that it can hold its shape when applied (enhancing surface cleanness and ease of operation) and exhibit a visually perceptible fuller appearance than an otherwise identical mayonnaise prepared using a conventional enzyme-modified yolk powder.

The provided modified egg yolk products feature enhanced functionality in emulsion applications, resulting in valuable savings, a cleaner label and less ingredient handling. If desired, these enzyme-modified egg products may be dried, frozen and refrigerated and can be used in baking applications, dressings and sauce formulations.

The term “viscosity” hereinthroughout refers to dynamic viscosity (μ), an indication of a fluid's resistance to flow, which is the tangential force per unit area necessary to move one plane past another at unit velocity at unit distance apart. It is. Its SI physical unit is the Pascal-second (Pas), which is identical to 1 kg/ms. The physical unit for dynamic viscosity in the centimeter gram second (cgs) system of units is the poise (P), more commonly expressed, particularly in ASTM standards, as centipoise (cP).

The following description is presented to enable a skilled artisan to make and use one or more embodiments of the inventive aspects. The general principles described herein may be applied to embodiments and applications other than those detailed below without departing from the spirit and scope of the disclosure. Therefore, the embodiments which follow are not exclusive but, instead, representative and are to be accorded the widest scope consistent with the principles and features disclosed or suggested herein.

Throughout this document, unless the surrounding text explicitly indicates a contrary intention, all values given in the form of percentages are w/w, pH values are those which can be obtained from any of a variety of potentiometric techniques employing a properly calibrated electrode, and recited numerical limitations include an appropriate degree of precision based on the number of significant places used; for example, “up to 5.0” can be read as setting a lower absolute ceiling than “up to 5.”

### BRIEF DESCRIPTION OF THE DRAWING

FIG. 1 is a plot of viscosity versus time for both pasteurized-but-unmodified (plain) yolk and an enzyme-modified yolk product.

FIGS. 2A and 2B are differential scanning calorimetry (DSC) plots for, respectively, plain dried egg yolk powder and an enzyme-modified yolk product powder.

FIG. 3 is a plot of mayonnaise viscosities against time for unmodified (plain) yolk and enzyme-modified yolk product powders.

### DESCRIPTION OF ILLUSTRATIVE EMBODIMENTS

Described here are enzyme-modified egg yolk products and methods for making the same. Modified egg yolks can be provided through the action of a food grade quality and regulatorily approved enzyme, which improves the emulsification properties by modifying yolk phospholipids. The enzymes may or may not be kosher and halal approved and certified and can be from different origins (e.g., animal and microbial).

Exemplary enzymes include Phospholipase A1 (PLA1) and A2 (PLA2), with the latter being preferred due to its ability to provide higher stability products. PLA2 is specifically designed for food applications, serving to catalyze hydrolysis of the fatty acid in the second position of phospholipids or lecithin. PLA2 splits the fatty acid in position two of phospholipids, hydrolyzing the bond between the second fatty acid “tail” and the glycerol backbone. It is specific for the sn-2 acyl bond of phospholipids and catalytically hydrolyzes phospholipids exclusively at the 2-position, giving rise to the formation of 1-acyl-3-sn-lysophospholipids and free fatty acids.

During enzymatic modification of egg yolks, phospholipids are converted into stable lysophospholipids (“LPLs”). Non-limiting examples of LPLs include lysophosphatidylcholine, lysophosphatidylethanolamine and lysophosphatidaylserine lysophosphatidic acid (radyl-lyso-glycerophosphate, LPA), 2,3-cyclic phosphatidic acid, 1-alkyl-2-acetyl-glycero-3-phosphate, sphingosine-1-phosphate (SIP), dihydro-sphingosine-1-phosphate, sphingosylphosphorylcholine (lysosphingomyelin, SPC), and lysophosphatidylcholine (LPC). Conversion of phospholipids to LPLs results in hydrolysis of the egg yolk.

LPLs provide enhanced emulsification relative to their phospholipid precursors due to increased hydrophilicity and molecular flexibility. They also tend to be more stable at or when exposed to elevated temperatures, e.g., greater than ˜90° C.

Enzymatic (PLA2) treatment of egg yolk before spray drying improves its surface activity and solubility. Without such treatment, the egg yolk loses interfacial activity (emulsion capacity and stability) when it reaches a temperature of ˜90° C. (e.g., 200° F.), often even at ˜75° C. (e.g., 170° F.), which often occurs when a product containing the yolk (e.g., a mayonnaise) is applied to a sandwich containing a cooked animal product such as meat protein.

When an enzyme-modified (hydrolyzed) egg yolk is spray dried, most moisture is removed. The PLA2 reaction adds hydrolytic phosphatide generation of lysophosphatide, and lysophosphatide provides advantages in molecular flexibility and high temperature resistance upon rehydration. The enzyme-modified egg yolk, after spray drying, provides high quality egg yolk powder having increased solubility, dispersibility, and flowability.

LPLs generated from the enzymatic modification inhibit breakage of emulsions (either oil-in-water or water-in-oil), which causes oil(s) to separate, flocculate, and form large clusters at elevated temperatures (e.g., ˜93° C.). This provides much desired heat stability to products such as, particularly, mayonnaise, permitting use in a broader range of applications and enhanced flexibility, for example, high temperature pasteurization/retort to improve microbiological safety and product shelf life.

A process for making an enzyme-modified egg yolk product according to the present invention now is described.

Raw liquid egg yolk from a commercial egg breaking line having a solids content of ˜44%±5% typically is employed as the starting material.

The liquid egg yolk is heated before other steps are performed. As suggested previously, heating the yolk is believed to impact yolk proteins and protein-fat complex(es) in a way that enhances their flexibility and susceptibility to interactions with other yolk components.

Pre-heating of the liquid egg yolk is performed in accordance with the Preheating Time-Temperature Correlation, with the length of heating varying inversely with the yolk's temperature according to formula (I) above. Specific, non-limiting exemplary embodiments include holding the liquid egg yolk at ˜59° C. (138° F.) for 325 to 335 seconds and at ˜61° C. (142° F.) for 205 to 215 seconds. These temperatures are for a static yolk temperature, i.e., situations where the yolk temperature is maintained within a narrow temperature range. However, if the yolk temperature varies due to, for example, use of a dynamic heating profile, the amount(s) of time at which the yolk is maintained at elevated temperature(s) can be adjusted, with such a modification being within the ambit of an ordinarily skilled artisan. Thus, by way of example, a yolk temperature might be raised from ˜59° C. (138° or 139° F.) to ˜61° C. (141° or 142° F.), or vice versa, over a period of heating ranging from, e.g., 225 to 275 seconds. (Other time-temperature combinations are contemplated.)

Before having its pH adjusted, as described below, the heated liquid egg yolk is cooled (or allowed to cool) somewhat. A target temperature generally is from ˜43° to ˜54° C. (110° to 130° F.), commonly from ˜46° to ˜52° C. (115° to 125° F.) and typically from ˜48° to ˜50° C. (119° to 122° F.). Other potentially useful ranges include from ˜44° to ˜53° C. (112° to 128° F.), from ˜45° to ˜52° C. (113° to 126° F.), and from ˜47° to ˜51° C. (116° to 124° F.).

Yolk pH is adjusted to close to 8.0, usually 8±0.25, commonly 8±0.2, typically 8±0.15, and preferably 8±0.1. (These pH values are those obtained from measurements at a temperature similar to those set forth in the preceding paragraph.) This can be accomplished with an aqueous solution of a GRAS base (e.g., NaOH or KOH) at a concentration (w/w) of ˜1 to ˜30%, preferably ˜4 to ˜15%, more preferably ˜4 to ˜7.5%, and most preferably ˜4 to ˜5%. The caustic solution is added with appropriate agitation/mixing to avoid localized pH shock.

To this pH-adjusted yolk is added enzyme. The enzyme can be obtained in liquid or dry form. If the latter is to be used, it should be dissolved in an excess of purified (e.g., deionized or distilled) water, e.g., at a ratio of from 1:2 to 1:10, of from 1:3 to 1:9, of from 1:4 to 1:8, or from 1:5 to 1:7.

Liquid enzyme (or enzyme solution) is added to the pH-adjusted yolk, with sufficient agitation to permit dispersion throughout the entirety of the container in which the pH-adjusted yolk is held. During mixing, addition or incorporation of air to the yolk preferably is minimized.

The amount of enzyme added is maintained in a fairly narrow window. Relative to the amount of egg yolk, the weight percentage of enzyme ranges from 0.0125 to 0.0175%, preferably from 0.013 to 0.017%, and more preferably from 0.014 to 0.016%.

The enzyme is permitted to catalyze the desired hydrolysis at a temperature of from ˜46° to ˜52° C. (115° to 125° F.), of from ˜47° to ˜50.5° C. (117° to 123° F.), and preferably of from ˜48° to ˜50° C. (119° to 122° F.). The length of the permitted reaction can depend on the temperature(s) employed, with exemplary ranges being ˜25 to ˜250 minutes, commonly 50 to 225 minutes, typically 75 to 200 minutes, more typically 100 to 175 minutes, and most typically 150 minutes ±10%.

During the enzymatic reaction, monitoring of the yolk pH and free fatty acid concentration can help to determine the degree of hydrolysis, which can vary somewhat based on the desired product functionality. In the industry, a common way to indicate degree of hydrolysis is by measuring the amount of oleic acid, an abundant and important unsaturated fatty acid with well documented nutritional significance. Fatty acids liberated through the enzymatically induced hydrolysis are converted to oleic acid, and the amount of that acid is measured.

Untreated yolk usually has a free fatty acid (in equivalent oleic acid) content of from ˜0.7% to ˜1.8% (w/w), varying based on breed, feed, and growth conditions. With the modified egg yolk product, prior to final (full) pasteurization, the weight percent of (equivalent) oleic acid present generally is in the range of from ˜4.0% to ˜6.0%, commonly from ˜4.8% to about 5.8%, and typically from ˜5.1% to about 5.7%; other exemplary ranges include ˜4.2% to ˜5.9%, ˜4.4% to ˜5.6%, ˜4.6% to ˜5.5%, ˜4.7% to ˜5.4%, or ˜4.9 to ˜5.3%. (The amount of oleic acid in the powder form does not differ significantly from the amount measured in the liquid form.)

The pH of the enzyme-modified egg yolk (without neutralization, measured at about ˜49° to ˜51° C. (120° to 124° F.) generally ranges from 6.7 or 6.8 to 7.3, commonly 6.8 or 6.9 to 7.2, and typically 7.0 to ˜7.2.

The viscosity of the liquid enzyme-modified egg yolk product (when measured after pasteurization) is significantly less than that of conventional enzyme-modified egg yolk products and near the upper end of the viscosity range for pasteurized egg yolk, i.e., 300-1000 cP on initial production date. Enzyme-modified liquid yolk usually exhibits a viscosity of 900±300 cP, commonly 925±200 cP, and typically 950±125 cP, when measured on Brookfield LV viscometer (Model DV-II+ Pro) at 30 rpm, #63 spindle, and 300 seconds elapsed time.

Without intending to be bound by theory, the moderate heat treatments employed in the present process, both initial (pre pH adjustment) and during pasteurization (discussed below), might reduce unfolding of the lipoproteins, minimizing the resulting intermolecular entanglement among these macromolecules and micelles. As a result, these macromolecules and micelles remain largely suspended, flexible and ready to interact and entangle with oil droplets added in when manufacturing food products like mayonnaise, salad dressing, etc., thus resulting in significantly enhanced finished product viscosity, even without changing ingredients and/or processing.

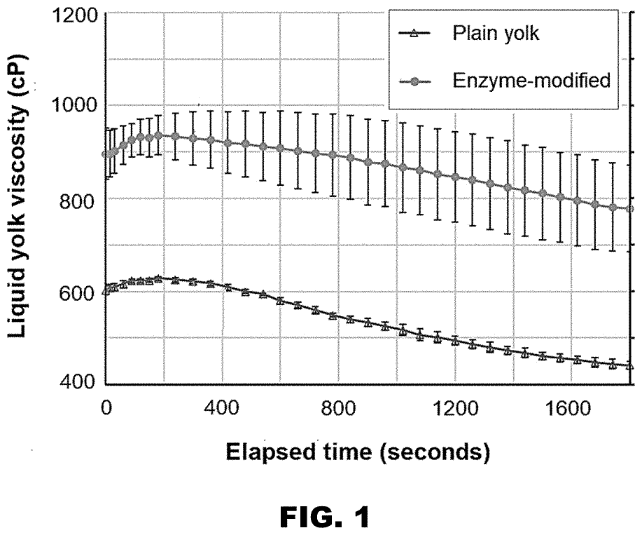

A comparison of viscosities of a pasteurized-but-unmodified (plain) yolk and an enzyme-modified yolk product is presented in FIG. 1. The results reported were means and standard deviations from three test repetitions (sample temperature of 4-5° C. at reading). The shape of the two plots are quite similar although, as apparent, that of the enzyme-modified yolk product is upwardly shifted by a significant amount (peak value of 929±57 cP for the enzyme-modified yolk product versus 621±5 cP for plain yolk).

The enzyme-modified (hydrolyzed) egg yolk preferably is pasteurized by being held at a temperature of from ˜60° to ˜67° C. (140° to 152° F.), from ˜61° to ˜66° C. (142° to 151° F.), from ˜62° to ˜66° (144° to 150° F.), or from ˜63° to ˜65° C. (145° to 149° F.). The length of time depends on the particular temperature(s) but generally ranges from 150 to 500 seconds, commonly from ˜200 to ˜480 seconds, typically from ˜225 to ˜475 seconds, more typically from ˜250 to ˜470 seconds, and most often from ˜275 to ˜465 seconds. An exemplary time-temperature combination is ˜61° to ˜62° or ˜64° C. (142° to 144° or 148° F.) for 350 to 450 seconds. These relatively moderate temperatures still have been found to be sufficient to eliminate all pathogenic microorganisms of concern and ensure product safety and shelf stability.

Regardless of whether pasteurized, the modified egg yolk is cooled below 5° C. or, preferably, 4.5° C. (40° F.).

The cooled product can be stored at refrigerator or freezer temperatures if it is to be used in liquid form.

Alternatively, for a shelf-stable product (which is convenient for shipping, handling, and customer incorporation into products such as mayonnaise), the liquid can be spray dried so as to provide a powder form. The spray drying of liquid egg yolk products is sufficiently well known that it does not require description here.

In addition to the aforementioned differences in free fatty acid weight percentages, the powder form of enzyme-modified egg yolks provided from the foregoing process have DSC characteristics distinct from those of plain yolk powder and previously available modified egg yolk powders.

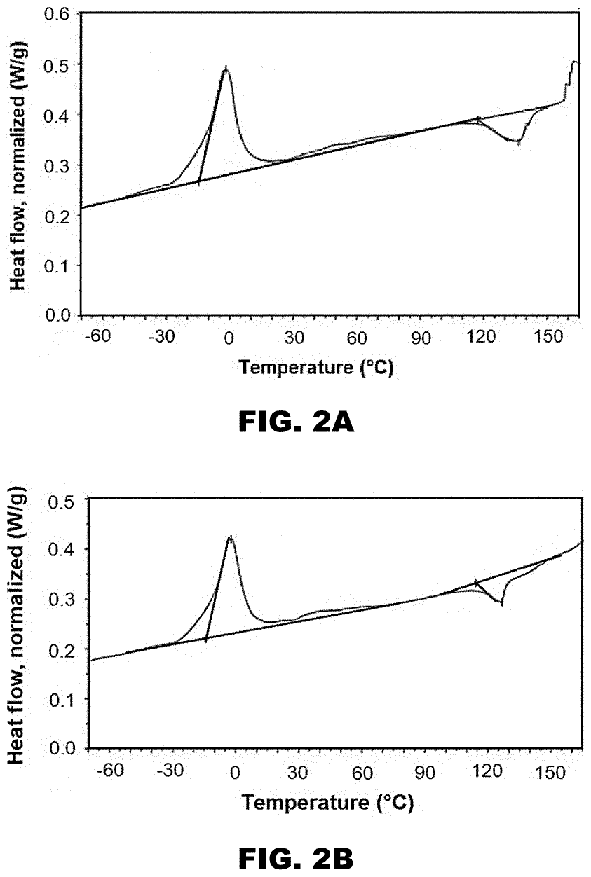

Thermographs of powdered enzyme-modified egg yolk products according to the present invention typically show slight right shifts for the exothermic peak but significant left shifts for the endothermic peak. This can be seen by comparing the DSC curves provided as FIGS. 2A and 2B, some key data of which is tabulated below, with all temperatures being provided in ° C. and enthalpies in J/g.

TABLE 1
DSC data

| | Endothermic peak, <30° C. | | | Exothermic peak, >100° C. | | |
|---|---|---|---|---|---|---|
| | Onset T | Peak T | Enthalpy | Onset T | Peak T | Enthalpy |
| plain yolk (FIG. 2A) | −14.7 | −1.8 | 23.73 | 117.2 | 136.5 | 6.01 |
| modified yolk (FIG. 2B) | −14.1 | −2.3 | 21.01 | 114.1 | 126.7 | 5.21 |

The endothermic peak (representing melting behaviors when sample temperature is ramped from below melting point of bound water) of the enzyme-modified egg yolk product has an onset temperature point right shifted 0.6° C. relative to plain yolk. This minor shift indicates a slightly higher melting point of the water (melting at a higher temperature), which further indicates slightly weaker bonds between moisture and its binding sites including protein side chain hydrophilic groups such as lysine's ω-amino group, serine's hydroxyl group and glutamic acid and aspartic acid's carboxyl groups. The ˜2.5 J/g decrease in enthalpy indicates significantly less energy is released from this phase transition process due to weaker moisture binding, in turn suggesting fewer water binding sites and binding of water.

The exothermic peak left shifted almost a full 10° C. relative to that of plain yolk, suggesting that the proteinaceous mass in the enzyme-modified yolk product starts its glass transition at a lower temperature (˜3° C.) than does plain yolk powder while requiring significantly less energy input to drive this phase transition process, again indicating entangling of proteins, both with other protein molecules and with other compounds in the matrix such as phospholipids, LPLs, triglycerides, and di-and monoglycerides was weaker, i.e., the proteins were more isolated. This transition's enthalpy decrease of ˜0.8 J/g indicates less energy is needed to activate this phase transition, suggesting less resistance to phase transition. This too is consistent with entanglements between proteins and other compounds being significantly less complicated, weaker, and more temperature-sensitive (early onset temperature) but less orderly (lower transition enthalpy). It further suggests that the proteinaceous-lipid entanglement within the enzyme-modified yolk product powder is more flexible, having a reduced degree of internal entanglement among yolk proteins, meaning they are more available for interaction with (including entanglements) other components (i.e., food ingredients) when formulated into a product like mayonnaise. This significantly stronger interaction and entanglements with other food ingredients, such as oil droplets, is believed to be a key factor in being able to provide a higher viscosity to products in which such modified yolk products are incorporated.

The enzyme-modified egg yolk, regardless of physical form, can be used to provide stable emulsions, and maintain them once formed. Fat droplet sizes are reduced to optimal levels, with or without the assistance of chemical emulsifier(s). Egg yolk proteins and their derivatives, particularly ones with appropriate polarities and sizes, coat the surfaces of the fat droplets and disperse in the continuous phase of the emulsion between droplets. While these proteins perform the necessary functions of preventing dispersed fat droplets from coalescing, they also impact viscosity, spreadability and mouthfeel of a product like mayonnaise. Current practices have focused on controlling degree of hydrolysis of phospholipids (reflected as percent free fatty acids in the enzyme-modified yolk) but not on process impacts on yolk protein functionalities and their interactions with yolk lipids and phospholipids, with alterations to those yolk proteins significantly impacting properties of a food product into which such yolk products are incorporated, e.g., mayonnaise, particularly the product viscosity.

The processing of the enzyme-modified egg yolk product discussed above can provide to mayonnaise products made therewith a higher-than-expected viscosity, which is determined largely by the properties of soluble egg yolk proteins and yolk protein/phospholipid complexes dispersed in the continuous phase. This is done through intentional alteration of yolk protein denaturation, yolk protein-lipid interactions, and solubility of these proteins and their derivatives.

By controlling these factors, one can provide high viscosity mayonnaise which still exhibits good stability and elevated temperatures. This can be done without changing the ingredients (e.g., addition of viscosifiers such as, for example, hydrocolloids) or ratios employed in the mayonnaise recipe. By way of exemplification only, a common amount of egg yolk employed in the manufacture of mayonnaise often is on the order of 2.8 to 3.2% (w/w) of powder or 6.5 to 6.7% (w/w) liquid.

Mayonnaise products made with the presently provided modified egg yolk products, even without otherwise changing existing recipes, can exhibit viscosities of at least 5000 cP, preferably at least 5100 cP, more preferably at least 5200 cP, even more preferably at least 5300 cP, still more preferably at least 5400 cP, and most preferably at least 5500 cP. (A manner for determining viscosity is provided below.) In terms of ranges, such mayonnaise products typically have viscosities of from 5000 to 6800 cP, from 5050 to 6750 cP, from 5100 to 6700 cP, from 5150 to 6600 cP, from 5200 to 6500 cP, from 5250 to 6400 cP, from 5300 to 6300 cP, from 5350 to 6200 cP, from 5400 to 6100 cP, or from 5450 to 6050 cP. This provides manufacturers an opportunity, without otherwise changing their recipes, to produce a heat stable (at a temperature higher than ˜93° C. (200° F.)) product which has the same or even higher viscosity.

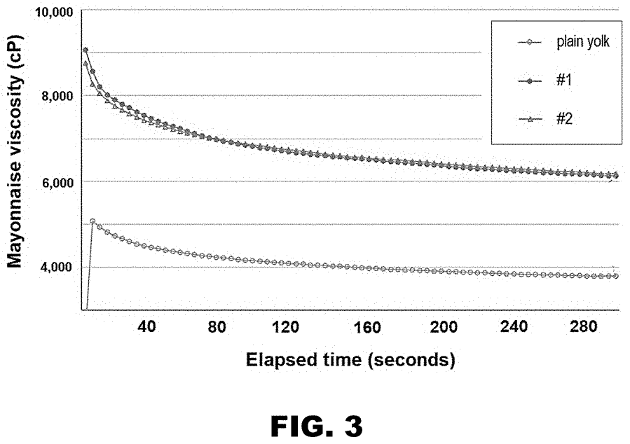

FIG. 3 shows a plot of viscosity against time for four mayonnaises made using the same ingredients and processing conditions. The weight percentage of each ingredient used in this recipe was as follows:
vegetable oil: 65.0%
egg yolk powder: 3.0%
xanthan gum: 0.1%
sugar: 3.0%
salt: 1.3%
water: 21.6%
5% vinegar solution: 6.0%.

One mayonnaise employed a plain yolk powder while three (designated #1 and #2) used a modified yolk powder according to the present invention.

The data show mayonnaise products incorporating enzyme-modified yolk product powders according to the present invention having increases in viscosity of ˜2300 to 2400 cP from that of a mayonnaise incorporating a plain yolk powder (˜3980 cP). Measurements were made using a Rapid Visco Analyzer, model 4500, at 20° C. and 160 rpm.

Many mayonnaises made with modified yolk powders according the present invention also can resist falling off a spoon held in an inverted position for >2 minutes at room temperature, a characteristic that cannot be achieved with plain yolk powders.

These and other mayonnaise products, additionally or alternatively, exhibit excellent emulsion stabilities at ˜93° C. (200° F.), ˜99° C. (210° F.), ˜104° C. (220° F.), or even higher. When measuring heat stability for the mayonnaise product, the mayonnaise is typically held for at least 10 seconds or longer at a temperature of ≥90° C. (e.g., 200° F.) to see whether the mayonnaise holds stable without any oil-off, breakdown, or separation. This can be accomplished on a 50 g mayonnaise sample in a glass bowl by heating in a 2250 watt microwave oven for 10 seconds twice with an interval or no more than 2 seconds; this heating regimen typically raises that size mayonnaise sample to a temperature of >90° C. (˜200° F.). A mayonnaise that holds stable without any oil-off, breakdown, or separation is considered to be heat stable.

Heat stability data for a mayonnaise made from the enzyme-modified egg yolk powder and for a mayonnaise made from plain egg yolk powder are tabulated below.

TABLE 2
mayonnaise heat stability evaluation

| | Temperature (° C.) | | Oil | Emulsion | |
|---|---|---|---|---|---|
| | 10 sec × 2 | 10 sec × 3 | separation | breakage | Burns? |
| plain yolk | 94.3 | — | Severe | Complete | Yes |
| modified yolk | 95.2 | 105.6 | No | No | No |

Heat stability is an important attribute, especially for retail sandwich manufacturing and mayonnaise manufacturers. Mayonnaise without this desired heat stability is usable in cold application such as refrigerated sandwiches or freshly built, made-to-order sandwiches, which in many cases do not require reheat. However, if a non-heat stable mayonnaise is used in retail applications where heat is a factor, the mayonnaise will exhibit oil separation (oil-off) due to emulsion breakdown, resulting in poor texture with undesired mouthfeel and taste. Mayonnaise with a broken emulsion exhibits separated oil and coats the tongue surface, causing poor mouthfeel, along with potential oil drops which stain clothing. Non-emulsified, free oil also interrupts sandwich taste by showing its source taste, such as beany notes for soy oil, particularly an aftertaste which reduces consumer satisfaction.

Emulsion breakage caused by using mayonnaises made with plain yolk also can be observed when mayonnaise applied to even fresh built sandwiches that happen to include grilled or cooked patties or meat components at a high temperature, i.e., ≥80° C. (˜175° F.). For food safety, heating meat components to a minimum of 71° C. (160° F.) is required although, in practice, much higher temperatures are reached so as to minimize risks resulting from heat process variations and product non-uniformity.

For retail sandwiches that require heat (or where heat is factor), and even where a reheating to a safe temperature is necessary (e.g., frozen sandwiches), a heat stable mayonnaise during heating or reheat will have limited, to no, oil-off, breakdown, or separation. The finished good has little-to-no mess, good texture, mouthfeel and taste in the end finished good

Additionally, manufacturers of bottled mayonnaise now can make products which can undergo pasteurization or even retort to provide, without the use of preservatives or chemical additives, desired microbiological safety and a significantly longer shelf life. Mayonnaise made with plain or currently available modified egg yolks cannot sustain the high temperatures employed in these processes, and instead rely on lower pH (and/or, in some cases, preservatives) to curb microorganism growth.

Use of the present enzyme-modified egg yolk product results in a very clean recipe with only egg yolk and phospholipase, along with necessary alkaline as processing aids for pH adjustment, in the ingredient statement. This enables mayonnaise manufacturers to bear clean label claims and help consumers avoid unnecessary exposure to chemical additives.

The following embodiments are specifically contemplated.

Embodiment [1] relates to a process for providing a modified (hydrolyzed) egg yolk product, said process comprising (a) heating liquid egg yolk to a temperature of from ˜57° to ˜61° C. (134° to 142° F.) in accordance with a Preheating Time-Temperature Correlation; (b) reducing said yolk temperature to ˜43° to ˜54° C. (110° to 130° F.); (c) adding a sufficient amount of an aqueous solution of a GRAS food grade base to said yolk so as to provide a caustic yolk having a pH of 8.05±0.25 units; (d) adding an enzymatic liquid to said caustic yolk; and (e) holding the resulting mixture at a temperature of from ˜46° to ˜52° C. (115° to 125° F.) for ˜50 to ˜250 minutes. The Preheating Time-Temperature Correlation is as follows:

141° to 142° F.-210 to 240 seconds,

140° to 141° F.-240 to 270 seconds,

139° to 140° F.-270 to 300 seconds,

138° to 139° F.-300 to 330 seconds,

136° to 138° F.-330 to 390 seconds, or

134° to 136° F.-390 to 450 seconds.

Embodiment [2] relates to the process of embodiment [1] further comprising pasteurizing said hydrolyzed egg yolk product.

Embodiment [3] relates to the process of any of embodiments [1] to [2] further comprising cooling said hydrolyzed egg yolk to a temperature of less than about 5° C.

Embodiment [4] relates to the process of any of embodiments [1] to [3] further comprising spray drying said hydrolyzed egg yolk so as to provide a modified egg yolk powder.

Embodiment [5] relates to the process of any of embodiments [1] to [4] wherein the caustic yolk provided has a pH from about 7.9 to about 8.1.

Embodiment [6] relates to a hydrolyzed liquid egg yolk comprising from 4 to 6% (w/w) oleic acid, said hydrolyzed liquid egg yolk optionally being provided from the process of any of embodiments [1] to [5].

Embodiment [7] relates to the hydrolyzed liquid egg yolk of embodiment [6] comprising at least 5% (w/w) oleic acid.

Embodiment [8] relates to the hydrolyzed liquid egg yolk of any of embodiments [6] to [7] wherein the pH of said egg yolk, measured at from 120° to 124° F., is from 6.8 to 7.3.

Embodiment [9] relates to a modified egg yolk powder provided from the hydrolyzed liquid egg yolk of any of embodiments [6] to [8], said powder optionally including at least 5% (w/w) oleic acid.

Embodiment [10] relates to a mayonnaise comprising a hydrolyzed egg yolk product but free of added thickeners, said mayonnaise being heat stable at 200° F. and having a dynamic viscosity at 20° C. of at least about 4700 cP when measured at or after 120 seconds and a shear speed of 160 rpm.

Embodiment [11] relates to the mayonnaise of embodiment [10] wherein said viscosity is measured at or after 240 seconds.

Embodiment [12] relates to the mayonnaise of embodiment [11] wherein said viscosity is measured at 300 seconds.

Embodiment [13] relates to the mayonnaise of any of embodiments [10] to [12] having a dynamic viscosity of at least about 5000 cP.

That which is claimed is:

1. A hydrolyzed liquid egg yolk comprising from 4 to 6% (w/w) oleic acid.

2. The hydrolyzed liquid egg yolk of claim 1 wherein the pH of said egg yolk, measured at from 49° to 51° C., is from 6.7 to 7.3.

3. The hydrolyzed liquid egg yolk of claim 2 wherein the pH is from 7.0 to 7.2.

4. The hydrolyzed liquid egg yolk of claim 3 having a viscosity of 925±200 cP.

5. The hydrolyzed liquid egg yolk of claim 4 having a viscosity of 950±125 cP.

6. The hydrolyzed liquid egg yolk of claim 2 having a viscosity of 900±300 cP when measured on Brookfield LV viscometer (Model DV-II+ Pro) at 30 rpm, #63 spindle, and 300 seconds elapsed time.

7. The hydrolyzed liquid egg yolk of claim 1 having a viscosity of 900±300 cP when measured on Brookfield LV viscometer (Model DV-II+ Pro) at 30 rpm, #63 spindle, and 300 seconds elapsed time.

8. A modified egg yolk powder provided from the hydrolyzed liquid egg yolk of claim 4.

9. The modified egg yolk powder of claim 8 wherein a differential scanning calorimetry thermograph thereof includes an endothermic peak, the enthalpy of said endothermic peak being less than 22.5 J/g.

10. The modified egg yolk powder of claim 8 wherein a differential scanning calorimetry thermograph thereof includes an exothermic peak having a peak temperature no greater than 53° C.

11. The modified egg yolk powder of claim 10 wherein said peak temperature is no greater than 50° C.

12. The modified egg yolk powder of claim 11 wherein the enthalpy of said exothermic peak is less than 5.5 J/g.

13. A mayonnaise comprising a hydrolyzed egg yolk product but free of added thickeners, said mayonnaise being heat stable at 93° C. and having a dynamic viscosity at 20° C. of at least 4700 cP when measured at or after 120 seconds and a shear speed of 160 rpm.

14. The mayonnaise of claim 13 wherein said viscosity is measured at or after 240 seconds.

15. The mayonnaise of claim 14 wherein said viscosity is measured at 300 seconds.

16. The mayonnaise claim 14 wherein said dynamic viscosity is at least 5000 cP.

17. The mayonnaise of claim 13 wherein said dynamic viscosity is at least 5000 cP.
